(19) United States
(12) Patent Application Publication
(10) Pub. No.: US 2013/0052946 A1
(43) Pub. Date: Feb. 28, 2013

(54) HOME AUTOMATION USING A MOBILE DEVICE

(71) Applicants: Manjirnath Chatterjee, San Francisco, CA (US); Eric Liu, Santa Clara, CA (US); William Grange, San Francisco, CA (US)

(72) Inventors: Manjirnath Chatterjee, San Francisco, CA (US); Eric Liu, Santa Clara, CA (US); William Grange, San Francisco, CA (US)

(21) Appl. No.: 13/215,501

(22) Filed: Aug. 23, 2011

(51) Int. Cl. H04B 5/00

(52) U.S. Cl. 455/41.1

(57) ABSTRACT

Embodiments of the present invention disclose a system and method for providing home automation using a mobile device. According to one embodiment, communication is established between the mobile device and a home appliance device, and a process request is sent from the mobile device to the home appliance device. In response, an operation associated with the received process request is executed by the home appliance device.

### BACKGROUND

The emergence and popularity of mobile computing has made portable electronic devices—due to their compact design and light weight—a staple in today's marketplace. Mobile devices such as smartphones involve advance computing functionality and are utilized for common tasks including email, internet surfing, gaming, and media capture/playback. Meanwhile, home automation systems provide centralized control for lighting, HVAC (heating, ventilation and air conditioning), appliances (such as refrigerators and dishwashers), and similar systems. However, these systems are difficult to upgrade as they typically have product lifecycles of approximately ten years. As a result, home automation technology is usually many years behind the technology of the latest mobile device.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a high level block diagram of a home automation system using a mobile device according to an example of the present invention.

FIG. 2 is a three-dimensional perspective view of a home automation system using a mobile device according to an example of the present invention.

FIG. 3 is an illustration of a mobile device communicating with a home appliance device according to an example of the present invention.

FIG. 4 is a simplified flow chart of the processing steps for implementing home automation using a mobile device according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

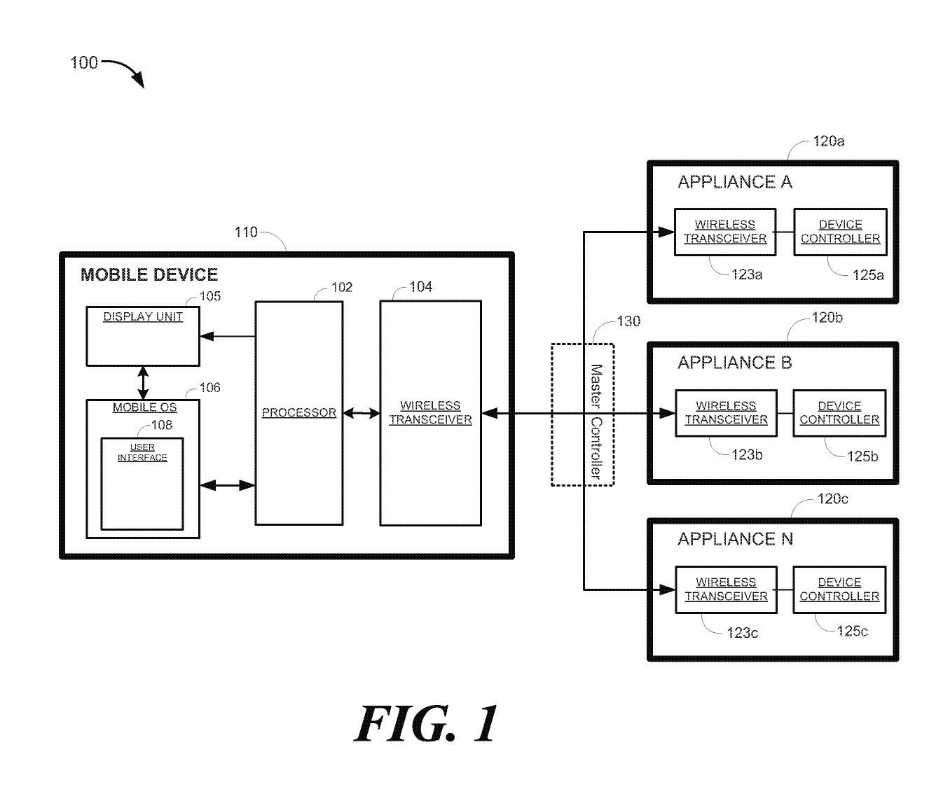

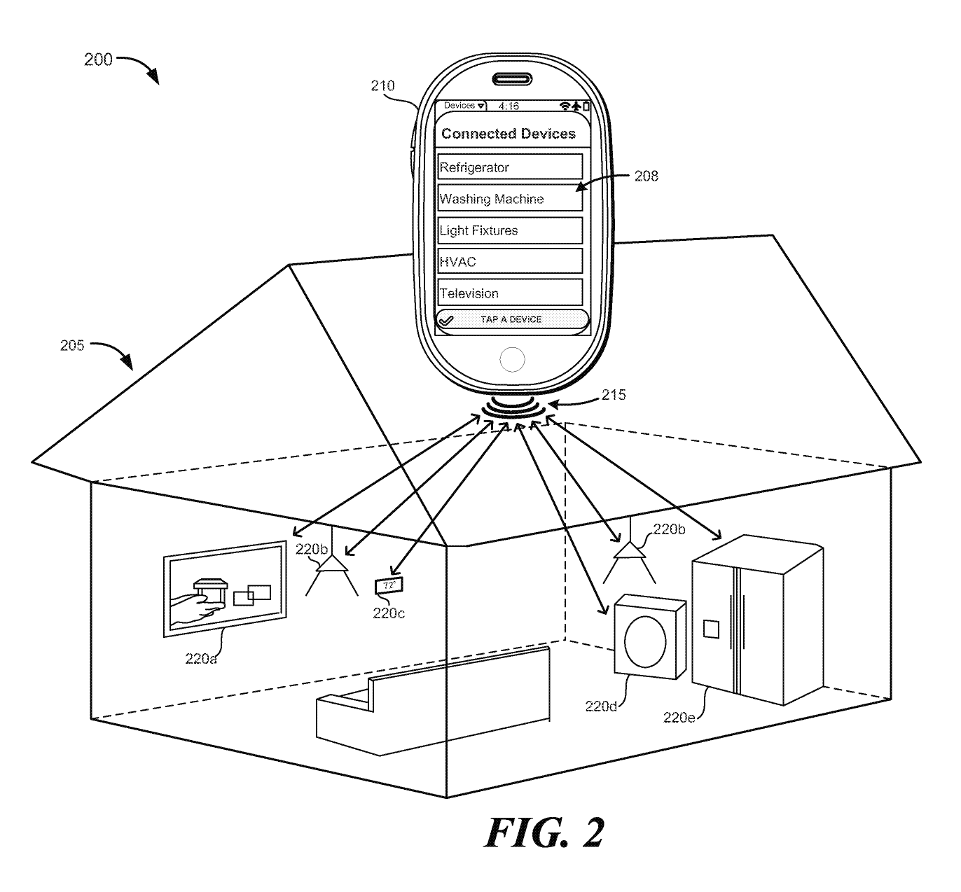

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Traditional home automation systems involve the use of a number of complex controllers and sensors. Prior solutions include implementation of a power line control protocol that allows communication between transmitters and receivers of various appliances by sending signals over existing house wiring. Still further, other systems utilize motion-activated sensors such that a light turns on or a surveillance camera activates upon someone entering a room or area. Such systems require the user to plug the appliance device or system into a proprietary module and undertake a timely and sometimes complex pairing process for interfacing the devices with a separate remote controller. Moreover, each system simply involves one-way communication between the remote controller and module and does allow for status updates or similar information to be transmitted from the appliance device/system back to the remote controller. Therefore, there is a need in the art for a simplified and robust home automation that offers two-way communication between devices.

Examples of the present invention disclose a system and method for home automation using a mobile device. According to one example embodiment, near filed communication (NFC) or any other short-ranged wireless communication protocol is utilized for allowing a mobile device to interact with various systems and appliances within the home environment. For instance, the mobile device may send process requests to an intermediary device controller installed within a target home appliance device. The process request may be executed locally on the device with status update information transmitted back to the mobile device.

Referring now in more detail to the drawings in which like numerals identify corresponding parts throughout the views, FIG. 1 is a high level block diagram of a home automation system using a mobile device according to an example of the present invention. As shown in this example, the system 100 includes a mobile device in communication with a number (N) of home appliance devices 120a-120c. The mobile device 110 includes a processor 102 coupled to a display unit 105, a mobile operating system 106, and a wireless transceiver 104. In one example embodiment, processor 102 represents a central processing unit (CPU), microcontroller, microprocessor, or logic configured to execute programming instructions associated with the mobile device 110. The display unit 105 of the mobile device represents an electronic visual display configured to display images and graphics for viewing by an operating user. The mobile operating system 106 includes a graphical user interface 108 for enabling input interaction 109 between an operating user and the mobile device 110. More particularly, the user interface 108 allows for the user to access and manage individual home application devices from the mobile device 110. To accomplish this functionality, the mobile device 110 includes a wireless transceiver for sending and receiving data to/from a particular home appliance device. According to one example embodiment, the mobile device 110 communicates with each home appliance device 120a-120c through a wireless communication means such as NFC or similar communication protocol that enables short-range wireless transfer of data between devices.

Still further, each home appliance device 120a-120c includes a wireless transceiver 125a-125c and device controller 125a-125c for facilitating communication with the mobile device. As will be used herein, home appliance devices represent any electrical or mechanical appliance, system, or machine used to perform a household function (e.g., oven for cooking, dishwasher for cleaning, light fixtures for illumination, refrigerator for storage, and HVAC for cooling/heating the home environment, etc.). Device controller 125a-125c may be a device or module electronically coupled to the home appliance device 120a-120c or an integrated unit of the home appliance device 120a-120, and is configured to execute programming instructions and control operations on the home appliance device such as controlling the temperature of a HVAC or toggling the light system on and off. According to one example embodiment, the mobile device 110 may establish communication with the device controller 125a-125c of an associated home appliance device 120a-120c respectively, via data transmission from the wireless transceiver 104 of the mobile device 110 to the wireless transceiver 123a-123c of an associated home appliance device 123a-123c.

According to one example, the wireless transceivers 123a-123c may be implemented within the device controller 125a-125c of the associated home appliance device 120a-120c. Additionally, a master controller 130 may be implemented between the mobile device 110 and device controller 125a-125c of each home appliance device 120a-120c. In such a configuration, the mobile device 110 would communicate directly with the master controller 130. Based on the information received from the mobile device 110, the master controller 130 would then manage the transmission of data to/from each home appliance device 120a-120c and device controller 125a-125c respectively. Furthermore, communication between the individual device controllers 125a-125c and the master controller 130 could be accomplished via radio frequency (RF), power lines, wireless fidelity, or any other communication interface scheme.

FIG. 2 is a three-dimensional perspective view of a home automation system using a mobile device according to an example of the present invention. In the present example embodiment, the home automation system 200 includes a mobile device 210 in communication with a number of home appliance devices 220a-220e within a house 205. As mentioned above, home appliance devices 220a-220e represent any electrical or mechanical appliance, system, or machine used to perform a household function. In the present example of FIG. 2, home appliance devices include a television 220a, light fixtures/system 202b, HVAC 120c, a smart dish washer or washing machine 220d, and a smart refrigerator 220e. According to one example embodiment, the mobile device 210 communicates with each device through a wireless communication means 215 such as NFC or similar communication protocol that enables short-range wireless transfer of data between two devices. As explained above, each home appliance device 220a-220e includes a device controller for executing process requests received from the mobile device 210. Moreover, execution of the process requests by the device controller could occur automatically based on a user entering a particular area of the home. In accordance with one example embodiment, the lighting, temperature, and/or television channel may change based on the location of the user, day of the week, and/or the time of day.

As an example of home automation with respect to a lighting system, a device controller may be included with or connected to each lighting fixture 220c. The device controller could be integrated with the lighting system or placed in electrical contact (e.g., power cord interface) with each lighting fixture 220c. According to one example, the operating user could program the lighting through the mobile device 210 enabled with wireless communication (e.g., near field communication). Specifically, the associated device controllers are configured to turn the lights 220c on and off based on process requests or instructions received from the mobile device 210 or master controller. When the mobile device 210 is present within a communicable field of the controller (master controller or device sub-controller) or physically tapped against a controller, the mobile device would gain access to the home appliance device thus allowing the user to set the brightness of the lighting fixture using the mobile device 210. Moreover, settings of the lighting system 220b could be automated such that lights automatically come on or turn off whenever the mobile device 210 and operating user enter or exit a room.

Similarly, the HVAC or thermostat 220c of the house 205 may also be controlled via the mobile device 210. In one example, thermostat control could be given to the operating user whenever the mobile device is physically tapped against the thermostat, or whenever the mobile device is placed within a communicable distance with the HVAC system such that credentials may be exchanged between the two devices (mobile device 210 and HVAC 220c). According to one example, the temperature of each room could be set intelligently according to preset preferences and the location of the mobile device 210 and operating user. For example, the device controller may automatically cause the thermostat to set to a temperature of 72° upon detecting the presence of the mobile device within a communication field (e.g., less than 20 cm) of the device controller or master controller.

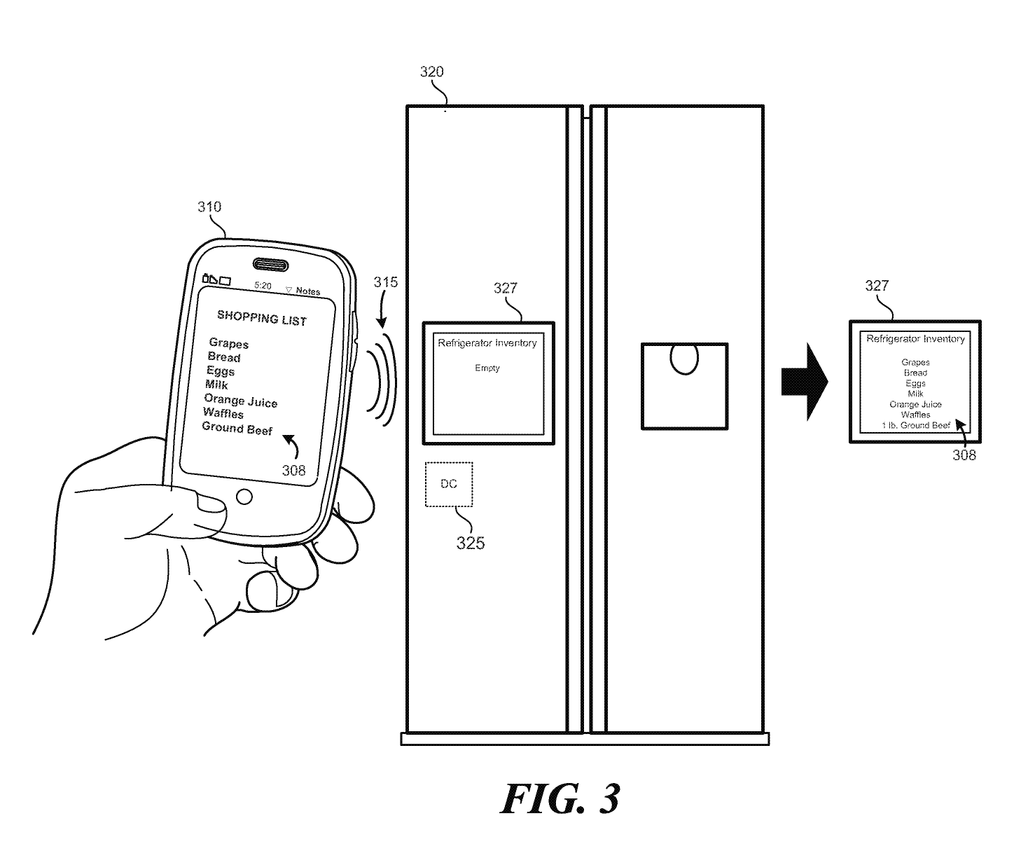

FIG. 3 is an illustration of a mobile device communicating with a home appliance device according to an example of the present invention. Here, the home automation system of the present example is used to track inventory information of a smart refrigerator 320 including an inventory display 327, which identifies the items residing within the refrigerator. The user may manually maintain a grocery list or have the mobile device 310 download information on purchased items via grocery store frequent shopper card information, credit card information, or the like. When the user returns home, the grocery information 308 may be transferred from the mobile device 310 to the refrigerator 320 through wireless communication means 315 (physical tap or when within near field). The device controller 323 of the refrigerator 320 could then update the inventory and display 327 based on the received grocery information. As shown in FIG. 3, the inventory list shown in display 327 is updated with the latest grocery information 308. Thus, examples of the present invention allow users to easily and accurately track the contents of their refrigerator using a mobile device.

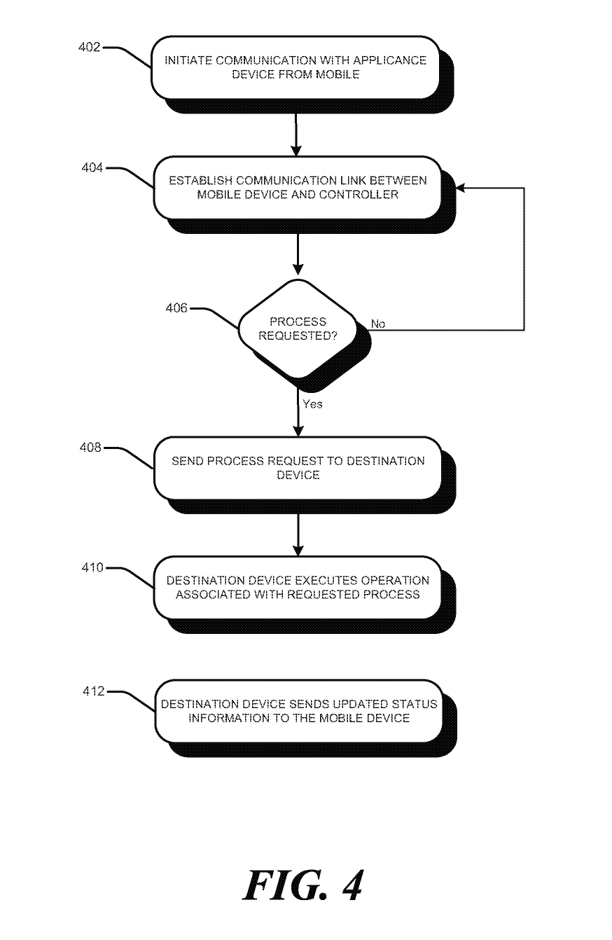

FIG. 4 is a simplified flow chart of the processing steps for implementing home automation using a mobile device according to an example of the present invention. In step 402, the mobile device initiates communication with the home appliance device. Communication initiation between devices may occur by positioning of the mobile device with a communicable distance or within the near field of the home automation device or master controller, or via a physical tap of the mobile device on the home appliance device or master controller. Furthermore, ether the mobile device or home appliance device may initiate said communication. For instance, a home appliance device such as a smart refrigerator may initiate communication with the mobile device to indicate the absence of certain inventory items (e.g., out of milk). According to one example, the mobile device may include a near field communication protocol that can be utilized for imitating and establishing connection with another wireless communication protocol (e.g., WiFi or Bluetooth) associated with the home appliance device. Next, in step 404 the master controller or device controller of the home appliance device establishes the communication link and pairing of the two devices.

If a service or process request is made by the user operating the mobile device in step 406, then the process request is sent to a destination appliance device via the wireless communication means in step 408. As used herein, a process request represents an action or operation to be executed by the home appliance device such as updating the inventory data of a refrigerator, changing the environment temperature of a HVAC, changing the cooking time of an oven, or simply turning a particular light fixture on or off. Thereafter, in step 410 the destination home appliance device executes an operation associated with the received process request and then updates the status information, which may be sent to the mobile device in step 412. For example, upon establishing communication between the mobile device and a smart oven, the user may send a process request to adjust the baking temperature from 375° to 425°. The device controller of the smart oven will execute an operation (i.e., temperature adjustment) associated with the received request and may then send the user an update of the estimated cook time (status information) based on the new temperature.

Embodiments of the present invention provide method and system for providing home automation using a mobile device. Moreover, many advantages are afforded by the home automation system and method in accordance with examples of the present invention. In particular, the home automation system can help integrate several home appliance devices with one centralized control interface (i.e., mobile device) while contemporaneously providing two-way communication between the device and central interface. Due to the accessibility of the walls, power outlets, storage rooms and the ability to make design changes specifically to accommodate the desired automation functionality, home automation was generally only implemented within a new home during construction. However, the configuration of the present examples allows for home automation integration in existing homes with minimal effort and little to no technical expertise. Furthermore, a simplified and efficient home automation system will provide increased quality of life for the elderly, disabled, and other persons who might otherwise require caregivers or institutional care.

Furthermore, while the invention has been described with respect to exemplary embodiments, one skilled in the art will recognize that numerous modifications are possible. For example, although exemplary embodiments depict a smartphone as the mobile device, the invention is not limited thereto. For example, the mobile device may be a netbook, a tablet personal computer, or any other portable electronic device enabled with short range wireless communication.

Furthermore, the home appliance devices available for control via the mobile device may include numerous additional devices than those discussed above and depicted in the accompanying figures. Thus, although the invention has been described with respect to exemplary embodiments, it will be appreciated that the invention is intended to cover all modifications and equivalents within the scope of the following claims.

What is claimed is:

1. A method for providing home automation using a mobile device, the method comprising:
establishing communication between the mobile device and a home appliance device;
sending, via the mobile device, a process request to the home appliance device;
executing, via the home appliance device, an operation associated with the received process request.

2. The method of claim 1, further comprising:
sending, via the home appliance device, status update information to the mobile device in response to the executed operation.

3. The method of claim 1, wherein the home appliance device includes a device controller and wireless transceiver configured to communicate with the mobile device.

4. The method of claim 1, wherein the mobile device and the home appliance device communicate via a near field communication protocol.

5. The method of claim 4, wherein the near filed communication protocol is utilized to establish a second wireless communication protocol.

6. The method of claim 5, wherein the home appliance device is a smart device enabled with a wireless communication protocol and includes a smart refrigerator, a smart oven, HVAC, or lighting system.

7. The method of claim 6, wherein the process request includes turning the lights of a lighting appliance on or off.

8. The method of claim 6, wherein the process request includes determining or updating an inventory list of the smart refrigerator.

9. The method of claim 6, wherein the process request includes changing the temperature of the HVAC from a current temperature to a new temperature.

10. The method of claim 1, wherein the step of sending the process request by the mobile device and executing the process request by the home appliance device is accomplished automatically.

11. A home automation system comprising:
at least one home appliance device having a device controller;
a mobile device configured to communicate with the device controller of the home appliance device and send a process request thereto;
wherein an operation associated with the process request sent from the mobile device is capable of being executed at the home appliance device via the device controller.

12. The system of claim 11, further comprising:
a master controller configured to communicate with the mobile device and the device controller of the home appliance device.

13. The system of claim 11, wherein status update information is transmitted from the home appliance device to the mobile device in response to the received process request.

14. The system of claim 11, wherein the home appliance device includes a wireless transceiver configured to communicate with the mobile device.

15. The system of claim 11, wherein the mobile device and the home appliance device communicate via a near field communication protocol.

16. The system of claim 15, wherein the near field communication protocol is utilized to establish a second wireless communication protocol.

17. The system of claim 16, wherein the home appliance device is a smart device enabled with a wireless communication protocol and includes a smart refrigerator, HVAC, or lighting appliance system.

18. The system of claim 17, wherein the process request includes turning the light of a lighting appliance system on or off, determining or updating an inventory list of the smart refrigerator, or changing the temperature of the HVAC from a current temperature to a new temperature.

19. The system of claim 11, wherein the device controller is integrated within the home appliance device.

20. A method for providing home automation using a mobile device, the method comprising:
initiating, via the mobile device, communication with at least one home appliance device of a plurality of home appliance devices;
sending, via the mobile device, a process request to the at least one home appliance device;
executing, via the at least one home appliance device, an operation based on the received process request.
sending, via the least one home appliance device, status update information to the mobile device in response to executed operation.
wherein the mobile device and the plurality of home appliance devices communicate via near field communication.
